(19) United States
(12) Patent Application Publication
(10) Pub. No.: US 2014/0017467 A1
(43) Pub. Date: Jan. 16, 2014

(54) PRESSURE SENSITIVE ADHESIVE SHEET

(71) Applicants: Youichi Inao, Tokyo (JP); Seitaro Yamaguchi, Tokyo (JP); Mikihiro Kashio, Tokyo (JP); Satoshi Kawada, Tokyo (JP)

(72) Inventors: Youichi Inao, Tokyo (JP); Seitaro Yamaguchi, Tokyo (JP); Mikihiro Kashio, Tokyo (JP); Satoshi Kawada, Tokyo (JP)

(73) Assignee: LINTEC CORPORATION, Tokyo (JP)

(21) Appl. No.: 14/008,338

(22) PCT Filed: Jan. 24, 2012
(86) PCT No.: PCT/JP12/51474

§ 371 Date: Sep. 27, 2013

(30) Foreign Application Priority Data
Mar. 31, 2011 (JP) 2011-077910

(51) Int. Cl. C09J 7/02

(52) U.S. Cl. CPC C09J 7/0207
USPC 428/214; 428/354

(57) ABSTRACT

The present invention relates to a pressure sensitive adhesive sheet including a pressure sensitive adhesive layer on at least one surface of a base material, wherein the pressure sensitive adhesive layer is made of a two-layer structure of a first pressure sensitive adhesive layer and a second pressure sensitive adhesive layer in this order from the side of the base material; a first pressure sensitive adhesive constituting the first pressure sensitive adhesive layer has a loss tangent (tan δ) value at 0° C. of 0.25 or more and a storage elastic modulus value at 0° C. of from 0.01 to 0.80 MPa; and a resin component contained in a second pressure sensitive adhesive constituting the second pressure sensitive adhesive layer contains from 10 to 100 t by mass of an acrylic copolymer having a crosslinkable functional group. The pressure sensitive adhesive sheet according to the present invention exhibits an excellent adhesive strength even when the pressure sensitive adhesive layer is reduced in thickness.

### TECHNICAL FIELD

The present invention relates to a pressure sensitive adhesive sheet, in particular, a pressure sensitive adhesive sheet which exhibits a desired adhesive strength even when a pressure sensitive adhesive layer thereof is reduced in thickness.

### BACKGROUND ART

The adhesive strength of a pressure sensitive adhesive sheet has dependency upon a coating amount of a pressure sensitive adhesive on a sheet, namely, a thickness of a pressure sensitive adhesive layer to be formed. In pressure sensitive adhesive sheets which are used for labels, tapes, and the like, the thickness of the pressure sensitive adhesive layer is set up in conformity with a variety of purposes. However, there are not many examples of making the thickness thinner than 10 μm from the viewpoint of exhibiting a sufficient adhesive strength.

However, in recent years, in electronic appliances, optical appliances, and the like, reduction of the thickness in products is desired, and pressure sensitive adhesive sheets which are used for joining or temporary bonding at the time of processing or the like of members constituting an electronic appliance or an optical appliance are also similarly desired to be reduced in thickness.

As for reduction of the thickness in the pressure sensitive adhesive layer in a pressure sensitive adhesive sheet which is used for joining or temporary bonding at the time of processing of members constituting an electronic appliance or an optical appliance, there have been made a variety of proposals. For example, in Patent Literatures 1 to 3, for the purpose of enhancing removable properties, it is contrived to lower the adhesive strength by reducing the pressure sensitive adhesive layer in thickness.

However, though there may be the case where reduction of the pressure sensitive adhesive layer in thickness is conducted as a measure for lowering the adhesive strength, there may also be the case where even when the pressure sensitive adhesive layer is reduced in thickness, a lowering of the adhesive strength is not occasionally desirable.

For example, for the purpose of providing an optical surface protective film having satisfactory bonding reliance (adhesive strength) to an optical member even when the pressure sensitive adhesive layer is reduced in thickness to a level of from about 2 to 10 μm, Patent Literatures 4 and 5 propose a surface protective film using a rubber based pressure sensitive adhesive.

In addition, for the purpose of providing a pressure sensitive adhesive type optical film capable of satisfying durability even in the case of reducing the pressure sensitive adhesive layer in thickness to a level of from 1 to 15 μm, Patent Literature 6 proposes a pressure sensitive adhesive type optical film using a pressure sensitive adhesive containing a (meth)acrylic polymer having a large weight average molecular weight and composed of a specified monomer and a crosslinking agent.

### CITATION LIST

### Patent Literature

Patent Literature 1: JP-A-2005-007618

Patent Literature 2: JP-A-2006-281488

Patent Literature 3: JP-A-2009-158503

Patent Literature 4: JP-A-2008-133435

Patent Literature 5: JP-A-2008-102271

Patent Literature 6: JP-A-2007-277510

### SUMMARY OF THE INVENTION

### Technical Problem

However, in the protective films or optical films disclosed in Patent Literatures 4 to 6, the adhesive strength is still insufficient at the time of reducing the pressure sensitive adhesive layer in thickness.

An object of the present invention is to provide a pressure sensitive adhesive sheet having a pressure sensitive adhesive layer, in particular, a pressure sensitive adhesive sheet which exhibits an excellent adhesive strength even when the pressure sensitive adhesive layer is reduced in thickness.

### Solution To Problem

The present inventors have found that the foregoing problem can be solved by a pressure sensitive adhesive sheet having a pressure sensitive adhesive layer on at least one surface of a base material, wherein the pressure sensitive adhesive layer is made of a two-layer structure composed of specified first pressure sensitive adhesive layer and second pressure sensitive adhesive layer.

Specifically, the present invention provides the following [1] to [4].
[1] A pressure sensitive adhesive sheet comprising a pressure sensitive adhesive layer on at least one surface of a base material, wherein the pressure sensitive adhesive layer is made of a two-layer structure of a first pressure sensitive adhesive layer and a second pressure sensitive adhesive layer in this order from the side of the base material; a first pressure sensitive adhesive constituting the first pressure sensitive adhesive layer has a loss tangent (tan δ) value at 0° C. of 0.25 or more and a storage elastic modulus value at 0° C. of from 0.01 to 0.80 MPa; and a resin component contained in a second pressure sensitive adhesive constituting the second pressure sensitive adhesive layer contains from 10 to 100% by mass of an acrylic copolymer having a crosslinkable functional group.
[2] The pressure sensitive adhesive sheet as set forth in above [1], wherein the acrylic copolymer having a crosslinkable functional group, which is contained in the second pressure sensitive adhesive, contains from 0.1 to 20% by mass of a constituent unit derived from a monomer having a carboxy group in all of constituent units of the acrylic copolymer.
[3] The pressure sensitive adhesive sheet as set forth in above [1] or [2], wherein the first pressure sensitive adhesive contains a urethane resin, a butyl rubber, or an acrylic copolymer.
[4] The pressure sensitive adhesive sheet as set forth in any one of above [1] to [3], wherein a total thickness of the first pressure sensitive adhesive layer and the second pressure sensitive adhesive layer is from 0.50 to 5.0 μm.

### Advantageous Effects of the Invention

The pressure sensitive adhesive sheet according to the present invention exhibits an excellent adhesive strength even when the pressure sensitive adhesive layer of the pressure sensitive adhesive sheet is reduced in thickness. According to this, the present invention is able to contribute to miniaturization and reduction in thickness of portable electronic appliances.

### BRIEF DESCRIPTION OF THE DRAWINGS

FIG. 1 is a cross-sectional view showing an embodiment of a configuration of a pressure sensitive adhesive sheet according to the present invention.

FIG. 2 is a cross-sectional view showing an embedment of a pressure sensitive adhesive sheet according to the present invention, which is different from the embodiment of FIG. 1.

### MODES FOR CARRYING OUT THE INVENTION

### [Pressure Sensitive Adhesive Sheet]

The pressure sensitive adhesive sheet according to the present invention is a pressure sensitive adhesive sheet comprising a pressure sensitive adhesive layer on at least one surface of a base material, wherein the pressure sensitive adhesive layer is made of a two-layer structure of a first pressure sensitive adhesive layer and a second pressure sensitive adhesive layer in this order from the side of the base material; a first pressure sensitive adhesive constituting the first pressure sensitive adhesive layer has a loss tangent (tan δ) value at 0° C. of 0.25 or more and a storage elastic modulus value at 0° C. of from 0.01 to 0.80 MPa; and a resin component contained in a second pressure sensitive adhesive constituting the second pressure sensitive adhesive layer contains from 10 to 100% by mass of an acrylic copolymer having a crosslinkable functional group.

In the pressure sensitive adhesive sheet according to the present invention, the first pressure sensitive adhesive layer plays a role of imparting plastic deformation properties, and the second pressure sensitive adhesive layer plays a role of exhibiting an adhesive strength due to an interaction at the interface between the pressure sensitive adhesive layer and an adherend. Accordingly, it may be considered that the pressure sensitive adhesive sheet according to the present invention exhibits an excellent adhesive strength even when the pressure sensitive adhesive layer is reduced in thickness to a level at which the pressure sensitive adhesive sheet is applied to electronic appliances, optical appliances, and the like.

The configuration of the pressure sensitive adhesive sheet according to the present invention is hereunder described.

Incidentally, in the following description, the weight average molecular weight (Mw) is a value as converted into standard polystyrene, which is measured by means of the gel permeation chromatography (GPC) method (hereinafter the same).

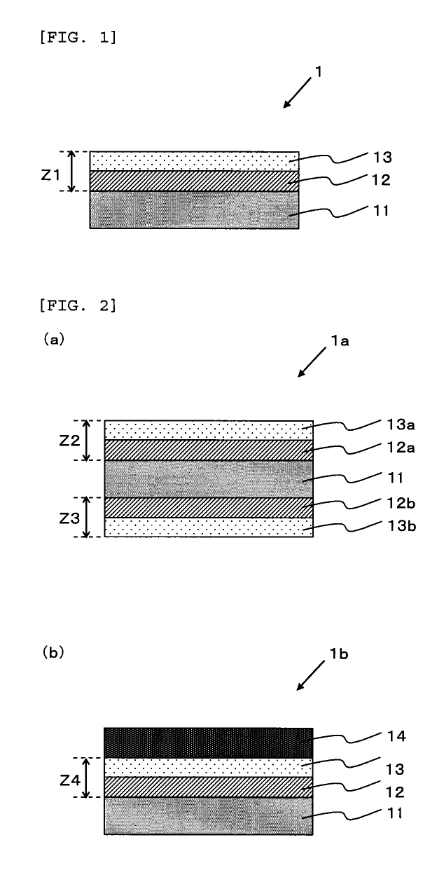

FIG. 1 is a cross-sectional view showing an embodiment of a configuration of the pressure sensitive adhesive sheet according to the present invention.

As shown in FIG. 1, a pressure sensitive adhesive sheet 1 according to the present invention is a pressure sensitive adhesive sheet having a pressure sensitive adhesive layer on at least one surface of a base material 11. The pressure sensitive adhesive layer is made of a two-layer structure of a first pressure sensitive adhesive layer 12 and a second pressure sensitive adhesive layer 13 in this order from the side of the base material 11. Namely, the first pressure sensitive adhesive layer 12 is formed on the base material 11, and the second pressure sensitive adhesive layer 13 is formed on the first pressure sensitive adhesive layer 12.

Incidentally, as shown in FIG. 2(a), the pressure sensitive adhesive sheet according to the present invention may be, for example, a pressure sensitive adhesive sheet la having first pressure sensitive adhesive layers 12a and 12b and second pressure sensitive adhesive layers 13a and 13b on the both surfaces of the base material 11 in this order from the side of the base material 11. In addition, as shown in FIG. 2(b), the pressure sensitive adhesive sheet according to the present invention may also be a pressure sensitive adhesive sheet 1b in which a release material 14 is further laminated on the second pressure sensitive adhesive layer 13. In addition, in the case of the pressure sensitive adhesive sheet having a pressure sensitive adhesive layer on each of the both surfaces as shown in FIG. 2(a), the release material may be provided on each of the both sides, or a structure of rolling up a single layer using a release material which has been subjected to a release treatment on the both surfaces thereof may be adopted.

In the present invention, it is meant by the terms “the pressure sensitive adhesive layer is reduced in thickness” that a total thickness of the first pressure sensitive adhesive layer and the second pressure sensitive adhesive layer (Z1 in FIGS. 1 and Z2 and Z3 in FIG. 2; hereafter also referred to as “thickness of the pressure sensitive adhesive layer”) is regulated to not more than 5.0 μm.

The pressure sensitive adhesive sheet according to the present invention may become a pressure sensitive adhesive sheet exhibiting an excellent adhesive strength even when the thickness of the pressure sensitive adhesive layer is regulated to not more than 5.0 μm.

The thickness of the pressure sensitive adhesive layer is preferably from 0.50 to 5.0 μm, more preferably from 0.55 to 3.8 μm, still more preferably from 0.60 to 3.0 μm, yet still more preferably from 0.65 to 2.5 μm, and especially preferably from 0.65 to 2.0 μm. When the thickness of the pressure sensitive adhesive layer is 0.50 μm or more, a sufficient adhesive strength can be obtained.

A ratio in thickness between the first pressure sensitive adhesive layer 12 and the second pressure sensitive adhesive layer 13 ((first pressure sensitive adhesive layer)/(second pressure sensitive adhesive layer)) is preferably from 1/4 to 4/1, more preferably from 1/3 to 3/1, and still more preferably from 1/2 to 2/1. When the thickness ratio is 1/4 or more, the adhesive strength can be exhibited while imparting plastic deformation properties of the first pressure sensitive adhesive layer at the lowest level. In addition, when the thickness ratio is not more than 4/1, a thickness at the lowest level at which the second pressure sensitive adhesive layer can interact with an adherend can be ensured, and a sufficient adhesive strength can be exhibited.

The adhesive strength of the pressure sensitive adhesive sheet according to the present invention is preferably 5.0 N/25 mm or more, more preferably 6.0 N/25 mm or more, still more preferably 7.0 N/25 mm or more, and yet still more preferably 8.0 N/25 mm or more, in the measurement method described in the Examples.

### [First Pressure Sensitive Adhesive]

A first pressure sensitive adhesive constituting the first pressure sensitive adhesive layer has a loss tangent (tan δ) value at 0° C. of 0.25 or more and a storage elastic modulus (G′) value at 0° C. of from 0.01 to 0.80 MPa.

Here, the loss tangent (tan δ) value at 0° C. of the pressure sensitive adhesive means a (loss elastic modulus)/(storage elastic modulus) ratio of the pressure sensitive adhesive and is an index of easiness of deformation (easiness of elongation) of the pressure sensitive adhesive. Incidentally, in the present invention, the loss tangent (tan δ) value is a value measured by the method described in the Examples.

When the loss tangent (tan δ) value at 0° C. is less than 0.25, the viscosity of the first pressure sensitive adhesive is lowered, and the transmission of a stress is too high, so that the pressure sensitive adhesive is broken in its early stages. As a result, the adhesive strength is lowered. Therefore, such is not preferable.

Though the loss tangent (tan δ) value at 0° C. is 0.25 or more, from the foregoing viewpoints, it is preferably from 0.27 to 0.90, more preferably from 0.30 to 0.80, still more preferably from 0.33 to 0.70, and yet still more preferably from 0.35 to 0.60.

On the other hand, in the present invention, the storage elastic modulus (G′) value is a value measured by the method described in the Examples.

When the storage elastic modulus (G′) value at 0° C. is less than 0.01 MPa, a stress due to deformation relative to the release strength is low (namely, work of bonding becomes low). As a result, the bonding strength is inferior. In addition, when the storage elastic modulus (G′) value at 0° C. exceeds 0.80 MPa, the amount of deformation of the pressure sensitive adhesive is small, and a sufficient bonding area cannot be ensured. As a result, the bonding strength is inferior.

Though the storage elastic modulus (G′) value at 0° C. is from 0.01 to 0.80 MPa, from the foregoing viewpoints, it is preferably from 0.03 to 0.70 MPa, more preferably from 0.05 to 0.60 MPa, still more preferably from 0.10 to 0.50 MPa, and yet still more preferably from 0.13 to 0.40 MPa.

In the present invention, the first pressure sensitive adhesive is not limited with respect to the kind or composition of the pressure sensitive adhesive to be used so long as the loss tangent (tan δ) value at 0° C. and the storage elastic modulus (G′) value at 0° C. fall within the foregoing ranges. It is possible to easily adjust the loss tangent (tan δ) value and the storage elastic modulus (G′) value by properly changing the kind or composition of the resin which is contained in the pressure sensitive adhesive.

However, from the viewpoint of easiness of the adjustment at the time of adjusting the loss tangent (tan δ) value and the storage elastic modulus (G′) value so as to fall within the foregoing ranges and also from the viewpoint of obtaining a sufficient adhesive strength when the thickness is reduced, it is preferable that the first pressure sensitive adhesive contains a urethane resin, a butyl rubber (isobutene-isoprene copolymer), or an acrylic copolymer.

The details of the urethane resin, the butyl rubber, and the acrylic copolymer, each of which is contained in the first pressure sensitive adhesive, are hereunder described.

### (Urethane Resin)

The urethane resin which is contained in the first pressure sensitive adhesive is not particularly limited. However, from the viewpoint of easiness of the adjustment at the time of adjusting the loss tangent (tan δ) value and the storage elastic modulus (G′) value so as to fall within the foregoing ranges and also from the viewpoint of obtaining a sufficient adhesive strength when the thickness is reduced, a urethane resin obtained by allowing an isocyanate-terminated urethane prepolymer obtained through a reaction of (b1) a polyol and (b2) a polyvalent isocyanate compound, to react with (b3) a chain extender is preferable.

Though the polyol (b1) is not particularly limited, examples thereof include polyol compounds such as alkylene diols, polyether type polyols, polyester type polyols, polycarbonate type polyols, etc. However, the polyol (b1) is not particularly limited so long as it is a polyol, and it may also be a diol which is difunctional or a triol which is trifunctional. Of these, the diol is preferable from the viewpoints of availability, reactivity, and the like.

Examples of the diol include alkanediols such as 1,3-propanediol, 1,4-butanediol, 1,5-pentanediol, neopentyl glycol, 1,6-hexanediol, 1,7-pentanediol, etc.; alkylene glycols such as ethylene glycol, propylene glycol, diethylene glycol, dipropylene glycol, etc.; polyalkylene glycols such as polyethylene glycol, polypropylene glycol, polybutylene glycol, etc.; polyoxyalkylene glycols such as polytetramethylene glycol, etc.; and the like. Incidentally, these diols may be used solely or in combination of two or more kinds thereof.

Of these diols, glycols having a weight average molecular weight of from 1,000 to 3,000 are preferable from the viewpoint of suppressing gelation in the reaction of the obtained isocyanate-terminated urethane prepolymer with the chain extender (b3).

Examples the polyvalent isocyanate compound (b2) include aromatic polyisocyanates, aliphatic polyisocyanates, alicyclic polyisocyanates, and the like.

Examples of the aromatic polyisocyanate include 1,3-phenylene diisocyanate, 1,4-phenylene diisocyanate, 4,4′-diphenylmethane diisocyanate (MDI), 2,4-tolylene diisocyanate (2,4-TDI), 2,6-tolylene diisocyanate (2,6-TDI), 4,4′-toluidine diisocyanate, 2,4,6-triisocyanate toluene, 1,3,5-triisocyanate benzene, dianisidine diisocyanate, 4,4′-diphenylether diisocyanate, 4,4′,4″-triphenylmethane triisocyanate, 1,4-tetramethylxylylene diisocyanate, 1,3-tetramethylxylylene diisocyanate, and the like.

Examples of the aliphatic polyisocyanate include trimethylene diisocyanate, tetramethylene diisocyanate, hexamethylene diisocyanate (HMDI), pentamethylene diisocyanate, 1,2-propylene diisocyanate, 2,3-butylene diisocyanate, 1,3-butylene diisocyanate, dodecamethylene diisocyanate, 2,4,4-trimethylhexamethylene diisocyanate, and the like.

Examples of the alicyclic polyisocyanate include 3-isocyanatomethyl-3,5,5-trimethylcyclohexyl isocyanate (IPDI), 1,3-cyclopentane diisocyanate, 1,3-cyclohexane diisocyanate, 1,4-cyclohexane diisocyanate, methyl-2,4-cyclohexane diisocyanate, methyl-2,6-cyclohexane diisocyanate, 4,4′-methylenebis(cyclohexyl isocyanate), 1,4-bis(isocyanatomethyl)cyclohexane, and the like.

Incidentally, the polyvalent isocyanate compound (b2) may be a modified product of the foregoing polyisocyanate, for example, a trimethylolpropane adduct type modified product, a biuret type modified product obtained by a reaction with water, or an isocyanurate type modified product having an isocyanurate ring incorporated thereinto.

Of these polyvalent isocyanate compounds (b2), one or more members selected from 4,4′-diphenylmethane diisocyanate (MDI), 2,4-tolylene diisocyanate (2,4-TDI), 2,6-tolylene diisocyanate (2,6-TDI), hexamethylene diisocyanate (HMDI), 3-isocyanatomethyl-3,5,5-trimethylcyclohexyl isocyanate (IPDI), and modified products thereof are preferable from the viewpoint of excellent physical properties of the pressure sensitive adhesive; and one or more members selected from HMDI, IPDI, and modified products thereof are especially preferable from the viewpoint of weather resistance.

A method for preparing the isocyanate-terminated urethane prepolymer is not particularly limited, and examples thereof include a method in which the components (b1) and (b2), and a urethanization catalyst which is optionally added, and a solvent are charged into a reactor and allowed to react with each other, and the like.

From the viewpoint of allowing an isocyanate group to remain in the end, the reaction is preferably conducted such that a blending ratio of the components (b1) and (b2) is preferably from 1.1 to 3.0, and more preferably from 1.2 to 2.5, in terms of a (molar number of NCO group)/(molar number of OH group) ratio. When the blending ratio is 1.1 or more, gelation can be prevented from occurring, so that a tendency of thickening can be suppressed. On the other hand, when it is not more than 3.0, a concentration of the unreacted polyvalent isocyanate compound in the isocyanate-terminated urethane prepolymer does not become excessively high, so that the reaction with the chain extender (b3) as described later can be made to proceed smoothly.

In addition, though the content of the isocyanate group (NCO %) in the isocyanate-terminated urethane prepolymer varies depending upon the reactivity between the components (b1) and (b2) to be used or the blending amount of the chain extender (b3), it is preferably from 0.5 to 12% by mass, and more preferably from 1 to 4% by mass, in terms of a value measured in conformity with JIS K1603. When the content of the isocyanate group is 0.5% by mass or more, the reaction with the chain extender (b3) can be made to sufficiently proceed, whereas when it is not more than 12% by mass, the reaction with the chain extender (b3) can be sufficiently controlled.

Though the catalyst which is used in the reaction for forming the isocyanate-terminated urethane prepolymer is not particularly limited, examples thereof include tertiary amine based compounds, organic metal based compounds, and the like.

Examples of the tertiary amine based compound include triethylamine, triethylenediamine, N,N-dime thylbenzylamine, N-methylmorpholine, 1,8-diazabicyclo[5.4.0]undecane-7 (DBU), and the like.

Examples of the organic metal based compound include tin based compounds and non-tin based compounds.

Examples of the tin based compound include dibutyltin dichloride, dibutyltin oxide, dibutyltin dibromide, dibutyltin dimaleate, dibutyltin dilaurate (DBTDL), dibutyltin diacetate, dibutyltin sulfide, tributyltin sulfide, tributyltin oxide, tributyltin acetate, triethyltin ethoxide, tributyltin ethoxide, dioctyltin oxide, tributyltin chloride, tributyltin trichloroacetate, tin 2-ethylhexanoate, and the like.

Examples of the non-tin based compound include titanium based compounds such as dibutyltitanium dichloride, tetrabutyl titanate, butoxytitanium trichloride, etc.; lead based compounds such as lead oleate, lead 2-ethylhexanoate, lead benzoate, lead naphthenate, etc.; iron based compounds such as iron 2-ethylhexanoate, iron acetyl acetonate, etc.; cobalt based compounds such as cobalt benzoate, cobalt 2-ethylhexanoate, etc.; zinc based compounds such as zinc naphthenate, zinc 2-ethylhexanoate, etc.; zirconium naphthenate; and the like.

Of these catalysts, DBTDL, tin 2-ethylhexanoate, and tetrabutyl titanate are preferable. Incidentally, these catalysts may be used solely or in combination of two or more kinds thereof.

The addition amount of the catalyst which is used in the reaction is preferably from 0.0001 to 1 part by mass, and more preferably from 0.005 to 0.1 parts by mass, based on 100 parts by mass of the component (b1) from the viewpoint of reactivity.

In addition, examples of the solvent which is used in the reaction include aromatic hydrocarbons such as toluene, xylene, etc., aliphatic hydrocarbons such as hexane, etc., esters such as ethyl acetate, butyl acetate, etc., ketones such as methyl ethyl ketone (MEK), etc., dimethylformamide, cyclohexanone, and the like. These solvents may be used solely or in combination of two or more kinds thereof.

A reaction temperature in the reaction is preferably not higher than 120° C., and more preferably from 70 to 100 ° C. When the reaction temperature is not higher than 120 ° C., the progress of an allophanate reaction is suppressed, the isocyanate group-terminated prepolymer having prescribed molecular weight and structure can be synthesized, and the reaction rate can be sufficiently controlled. Incidentally, for example, in the case where the reaction temperature is from 70 to 100° C., a reaction time in the reaction is preferably from 2 to 20 hours.

The thus obtained isocyanate-terminated urethane prepolymer is formed into a urethane resin upon a chain extension reaction with the chain extender (b3).

Though the chain extender (b3) is not particularly limited, it is preferable to use (b4) a compound having two groups consisting of hydroxyl groups and/or amino groups or (b5) a compound having three or more groups consisting of hydroxyl groups and/or amino groups.

The component (b4) is not particularly limited so long as it is a compound having two groups consisting of hydroxyl groups and/or amino groups. In view of the fact that a lowering of the adhesive strength can be more prevented from occurring, at least one compound selected from the group consisting of aliphatic diols, aliphatic diamines, alkanolamines, bisphenols, and aromatic diamines is preferable.

Examples of the aliphatic diol include alkanediols such as 1,3-propanediol, 1,4-butanediol, 1,5-pentanediol, neopentyl glycol, 1,6-hexanediol, 1,7-heptanediol, etc.; and alkylene glycols such as ethylene glycol, propylene glycol, diethylene glycol, dipropylene glycol, etc.

Examples of the aliphatic diamine include ethylenediamine, 1,3-propanediamine, 1,4-butanediamine, 1,5-pentanediamine, 1,6-hexanediamine, and the like.

Examples of the alkanolamine include monoethanolamine, monopropanolamine, isopropanolamine, and the like.

Examples of the bisphenol include bisphenol A and the like.

Examples of the aromatic diamine include diphenylmethanediamine, tolylenediamine, xylylenediamine, and the like.

The component (b5) is not particularly limited so long as it is a compound having three or more groups consisting of hydroxyl groups and/or amino groups. Examples thereof include polyols such as trimethylolpropane, ditrimethylolpropane, pentaerythritol, dipentaerythritol, etc.; amino alcohols such as 1-amino-2,3-propanediol, 1-methylamino-2,3-propanediol, N-(2-hydroxypropylethanolamine), etc.; an ethylene oxide adduct or propylene oxide adduct of tetramethylxylylenediamine; and the like.

The amino group and/or hydroxyl group in the components (b4) and (b5) is preferably a primary amino group, a secondary amino group, or a primary hydroxyl group from the viewpoint of reactivity with the isocyanate group.

A blending ratio of the component (b4) and the compound (b5) (mass ratio: (b4)/(b5)) is preferably from 7/3 to 10/0, and more preferably from 8/2 to 9/1. In the case where the blending ratio is 7/3 or more, even when the pressure sensitive adhesive layer is reduced in thickness, a lowering of the adhesive strength can be suppressed, and at the time of the chain extension reaction for obtaining a urethane resin, gelation can be avoided from occurring, and a desired pressure sensitive adhesive can be obtained.

Examples of the chain extension reaction include (1) a method in which a solution of the isocyanate group-terminated prepolymer is charged into a reactor, the chain extender is added dropwise in the reactor, and the mixture is allowed to react with each other; (2) a method in which the chain extender is charged into a reactor, a solution of the isocyanate group-terminated prepolymer is added dropwise, and the mixture is allowed to react with each other; and (3) a method in which a solution of the isocyanate group-terminated prepolymer is diluted with a solvent, a prescribed amount of the chain extender is then added collectively in a reactor, and the mixture is allowed to react with each other. In view of the fact that a uniform resin is easily obtainable because the isocyanate group is gradually decreased, the method (1) or (3) is preferable.

As the solvent, there can be used the same solvent to be used in the reaction for forming the isocyanate group-terminated prepolymer.

Though the addition amount of the chain extender (total addition amount of the components (b4) and (b5)) varies depending upon the content of an NCO group of the isocyanate group-terminated prepolymer, it is an amount such that the content of the NCO group of the urethane resin after the chain extension is preferably from 0.01 to 1.0% by mass, and more preferably from 0.05 to 0.2% by mass. When the addition amount of the chain extender is 0.01% by mass or more, a phenomenon in which thickening abruptly occurs at the time of the chain extension reaction, thereby causing gelation can be suppressed from occurring. In addition, when the addition amount of the chain extender is not more than 1.0% by mass, the chain extension reaction can be sufficiently conducted, so that the urethane resin having a desired molecular weight is obtainable.

A reaction temperature in the chain extension reaction is preferably not higher than 80° C. When the reaction temperature is not higher than 80° C., the reaction rate can be sufficiently controlled, and a urethane resin having desired molecular weight and structure is obtainable. Incidentally, in the case of conducting the chain extension reaction in the presence of a solvent, the reaction temperature is preferably not higher than a boiling point of the solvent, and in particular, the reaction temperature is preferably from 40 to 60° C. in the presence of MEK or ethyl acetate.

Incidentally, for example, in the case where the reaction temperature is from 40 to 80° C., the reaction time in the chain extension reaction is preferably from 1 to 20 hours.

Incidentally, a chain terminating agent may be used, for the purpose of terminating the chain extension reaction.

Examples of the chain terminating agent include a compound having only one active hydrogen capable of reacting with the isocyanate group or a compound having only one amino group.

Examples of the compound having only one active hydrogen capable of reacting with the isocyanate group include monool compounds such as methanol, ethanol, etc.

As the compound having only one amino group, there can be used a compound having a primary amino group or a secondary amino group, and examples thereof include diethylamine, morpholine, and the like.

The compound having one primary amino group has two active hydrogens; however, after one of the active hydrogens has reacted, the remaining active hydrogen has low reactivity, and hence, the compound becomes substantially equivalent to a monofunctional compound.

The addition amount of the chain terminating agent is preferably an amount at which a proportion of the chain terminating agent is 1 mole or more and not more than 2 moles per mole of the terminal isocyanate group remaining after the chain extension reaction. When the addition amount of the chain terminating agent is less than 1 mole, the isocyanate group retains after the terminating reaction, so that the obtained urethane resin becomes instable. On the other hand, when the addition amount of the chain terminating agent exceeds 2 moles, there is a tendency that a urethane resin having a low molecular weight increases.

A weight average molecular weight of the urethane resin is preferably from 10,000 to 300,000, more preferably from 30,000 to 250,000, and still more preferably from 50,000 to 200,000. When the weight average molecular weight of the urethane resin is 10,000 or more, there is a tendency that adhesive characteristics, in particular, a holding power is enhanced, whereas when it is not more than 300,000, gelation can be prevented from occurring.

### (Butyl Rubber (Isobutene-Isoprene Copolymer))

The butyl rubber which is used in the present invention is a copolymer of isobutene and isoprene and can be obtained upon irradiation with active energy rays to allow a crosslinking reaction to proceed.

The butyl rubber which is contained in the first pressure sensitive adhesive is not particularly limited. However, in view of the fact that after the irradiation with ultraviolet rays, the butyl rubber is sufficiently crosslinked to obtain an adequate cohesive strength, a degree of unsaturation of the butyl rubber to be used (content of an isoprene-derived constituent unit in the whole of the copolymer) is preferably from 0.1 to 10% by mole, more preferably from 0.5 to 7% by mole, and still more preferably from 1.0 to 5% by mole.

A weight average molecular weight of the butyl rubber is preferably from 20,000 to 500,000, more preferably from 30,000 to 450,000, and still more preferably from 100,000 to 400,000 from the viewpoint of not only obtaining satisfactory coating aptitude and film strength but adjusting the loss tangent (tan δ) value and the storage elastic modulus (G′) value so as to fall within the prescribed ranges.

In the case of using the butyl rubber, it is preferable to further contain a photopolymerization initiator.

Examples of the photopolymerization initiator include benzophenone, acetophenone, benzoin, benzoin methyl ether, benzoin ethyl ether, benzoin isopropyl ether, benzoin isobutyl ether, benzoin benzoic acid, benzoin methyl benzoate, benzoin dimethyl ketal, 2,4-diethylthioxanthone, 1-hydroxycyclohexyl phenyl ketone, benzyl diphenyl sulfide, tetramethylthiuram monosulfide, azobisisobutyronitrile, benzil, dibenzil, diacetyl, β-chloranthraquinone, (2,4,6-trimethylbenzyldiphenyl)phosphine oxide, 2-benzothiazole-N,N-diethyl dithiocarbamate, oligo{2-hydroxy-2-methyl-1-[4-(1-propenyl)phenyl]propanone}, 2-hydroxy-2-methyl-1-phenyl-propan-1-one, and the like. These photopolymerization initiators may be used solely or in combination of two or more kinds thereof.

In view of the fact that not only after the irradiation with ultraviolet rays, the butyl rubber is sufficiently crosslinked, but the addition amount is suppressed to such an extent that the physical properties are not affected, a blending amount of the photopolymerization initiator is preferably from 0.01 to 8 parts by mass, more preferably from 0.05 to 5 parts by mass, and still more preferably from 0.1 to 3 parts by mass, based on 100 parts by mass of the resin component in the pressure sensitive adhesive.

### (Acrylic Copolymer)

The acrylic copolymer which is contained in the first pressure sensitive adhesive (hereinafter also referred to as “acrylic copolymer (1)”) is not particularly limited.

In the present invention, the “acrylic copolymer” means an acrylic copolymer obtained by polymerizing a monomer mixture composed mainly of a (meth)acrylate ester. The (meth)acrylate as referred to herein means both of acrylate and methacrylate (the same is also applicable to other analogous terminologies).

In the first pressure sensitive adhesive, the content of the (meth)acrylate ester which is contained in the monomer mixture as a raw material of the acrylic copolymer (1) is usually 60% by mass or more. The content of the (meth)acrylate ester is preferably from 92 to 99.9% by mass, and more preferably from 95 to 99.5 by mass from the viewpoint of adjusting the loss tangent (tan δ) value and the storage elastic modulus (G′) value so as to fall within the prescribed ranges.

Examples of the (meth)acrylate ester that is the main component monomer include methyl(meth)acrylate, ethyl(meth)acrylate, propyl(meth)acrylate, butyl(meth)acrylate, pentyl(meth)acrylate, hexyl(meth)acrylate, cyclohexyl(meth)acrylate, 2-ethylhexyl(meth)acrylate, isooctyl(meth)acrylate, decyl(meth)acrylate, dodecyl(meth)acrylate, myristyl(meth)acrylate, palmityl(meth)acrylate, stearyl(meth)acrylate, and the like.

Of these, butyl(meth)acrylate is preferable. Incidentally, these (meth)acrylate esters may be used solely or in combination of two or more kinds thereof. In addition, in the case of using a combination of two or more kinds of (meth)acrylate esters, one of the monomers is preferably butyl acrylate. The content of butyl acrylate is preferably from 50 to 100% by mass, more preferably from 70 to 100% by mass, and still more preferably from 80 to 100% by mass, in the (meth)acrylate ester.

From the viewpoint of adjusting the loss tangent (tan δ) value and the storage elastic modulus (G′) value so as to fall within the prescribed ranges, it is preferable that a monomer having a crosslinkable functional group is contained in the monomer mixture as a raw material of the acrylic copolymer (1).

Examples of the crosslinkable functional group include functional groups capable of reacting with a crosslinking agent as described later, such as a carboxy group, a hydroxyl group, an amino group, etc. Of these crosslinkable functional groups, a carboxy group is preferable from the viewpoint of reactivity with the crosslinking agent and also from the viewpoint of its influences against the loss tangent (tan δ) value and the storage elastic modulus (G′) value.

Examples of the monomer having a crosslinkable functional group include ethylenically unsaturated carboxylic acids such as (meth)acrylic acid, itaconic acid, crotonic acid, maleic acid, fumaric acid, etc.; hydroxyalkyl(meth)acrylates such as 2-hydroxyethyl(meth)acrylate, 2-hydroxypropyl(meth)acrylate, 4-hydroxybutyl(meth)acrylate, 3-hydroxypropyl(meth)acrylate, 2-hydroxybutyl(meth)acrylate, 3-hydroxybutyl(meth)acrylate, etc.; monoalkylaminoalkyl(meth)acrylates such as monomethylaminoethyl(meth)acrylate, monoethylaminoethyl(meth)acrylate, monomethylaminopropyl(meth)acrylate, monoethylaminopropyl(meth)acrylate, etc.; and the like. Incidentally, these monomers may be used solely or in combination of two or more kinds thereof.

Of these, ethylenically unsaturated carboxylic acids are preferable from the viewpoint of adjusting the loss tangent (tan δ) value and the storage elastic modulus (G′) value so as to fall within the prescribed ranges.

The content of the monomer having a crosslinkable functional group is preferably from 0.1 to 8% by mass, and more preferably from 0.5 to 5% by mass, in the monomer mixture as a raw material of the acrylic copolymer from the viewpoint of adjusting the loss tangent (tan δ) value and the storage elastic modulus (G′) value so as to fall within the prescribed ranges.

As the constituent unit of the acrylic copolymer (1), a constituent unit derived from other monomer may be contained so long as the loss tangent (tan δ) value and the storage elastic modulus (G′) value are allowed to fall within the prescribed ranges.

Examples of other monomer include vinyl esters such as vinyl acetate, vinyl propionate, etc.; olefins such as ethylene, propylene, isobutylene, etc.; halogenated olefins such as vinyl chloride, vinylidene chloride, etc.; aromatic vinyl monomers such as styrene, methylstyrene, vinyltoluene, etc.; diene based monomers such as butadiene, isoprene, chloroprene, etc.; nitrile based monomers such as (meth)acrylonitrile, etc.; and the like. These monomers may be used solely or in combination of two or more kinds thereof.

In the present invention, the acrylic copolymer (1) is not particularly limited with respect to a copolymerization form thereof and may be any of a random, block, or graft copolymer.

Incidentally, from the foregoing viewpoints, the acrylic copolymer having a crosslinkable functional group contains a constituent unit derived from a monomer having a carboxy group in an amount of preferably from 0.1 to 20% by mass, more preferably from 0.5 to 15% by mass, and still more preferably from 1 to 12% by mass.

A weight average molecular weight of the acrylic copolymer (1) which is contained in the first pressure sensitive adhesive is preferably from 700,000 to 1,500,000, more preferably from 750,000 to 1,200,000, and still more preferably from 800,000 to 1,000,000 from the viewpoint of adjusting the loss tangent (tan δ) value and the storage elastic modulus (G′) value so as to fall within the prescribed ranges.

The preparation of the acrylic copolymer (1) can be conducted in the usual way in the presence or absence of a solvent. Examples of the solvent include ethyl acetate, toluene, and the like.

In addition, at the time of preparation, a polymerization initiator may also be used. Examples of the polymerization initiator include azobisisobutyronitrile, benzoyl peroxide, and the like. The addition amount of the polymerization initiator is preferably from 0.01 to 1 part by mass, and more preferably from 0.1 to 0.5 parts by mass, based on 100 parts by mass of the monomer mixture.

Though the polymerization conditions are not particularly limited, the polymerization is preferably conducted under conditions at from 50 to 90° C. for from 2 to 30 hours.

### [Second Pressure Sensitive Adhesive]

The second pressure sensitive adhesive constituting the second pressure sensitive adhesive layer of the pressure sensitive adhesive sheet according to the present invention contains from 10 to 100% by mass of an acrylic copolymer having a crosslinkable functional group (hereinafter also referred to as “acrylic copolymer (2)”) in the resin component contained in the second pressure sensitive adhesive. When the content of the acrylic copolymer (2) is less than 10% by mass, a sufficient adhesive strength to an adherend is not obtained. Incidentally, the acrylic copolymer (2) may be used solely or in combination of two or more kinds thereof.

The content of the acrylic copolymer (2) is preferably from 12 to 100%; by mass, more preferably from 15 to 100% by mass, and still more preferably from 18 to 100% by mass, in the resin component of the second pressure sensitive adhesive from the foregoing viewpoint.

Incidentally, in the second pressure sensitive adhesive, though other resin component than the acrylic copolymer having a crosslinkable functional group is properly changed depending upon an application of the pressure sensitive adhesive sheet, examples thereof include urethane resins, acrylic urethane resins, urethane polyester resins, and the like. Of these, urethane resins are preferable from the viewpoint of enhancing the adhesive strength to an adherend.

(Acrylic Copolymer having a Crosslinkable Functional Group)

The acrylic copolymer having a crosslinkable functional group, which is contained in the second pressure sensitive adhesive, means an acrylic copolymer obtained by polymerizing a monomer mixture containing, as a main component, a (meth)acrylate ester and, as a subcomponent, a monomer having a crosslinkable functional group capable of reacting with a crosslinking agent.

The content of the constituent unit derived from a (meth)acrylate ester in all of constituent units of the acrylic copolymer (2) is usually 60% by mass or more, preferably from 80 to 99.9 by mass, still more preferably from 85 to 99.5 by mass, and yet still more preferably from 88 to 99% by mass.

Examples of the crosslinkable functional group include a carboxy group, a hydroxyl group, an amino group, and the like. Of these, a carboxy group and a hydroxyl group are preferable from the viewpoint of reactivity with a crosslinking agent, and a carboxyl group is more preferable from the viewpoint of obtaining a high adhesive strength due to a reaction with an isocyanate based crosslinking agent.

Examples of the (meth)acrylate ester that is a main component monomer of the acrylic copolymer (2) include methyl(meth)acrylate, ethyl(meth)acrylate, propyl(meth)acrylate, butyl(meth)acrylate, pentyl(meth)acrylate, hexyl(meth)acrylate, cyclohexyl(meth) acrylate, 2-ethylhexyl(meth)acrylate, isooctyl(meth)acrylate, decyl(meth)acrylate, dodecyl(meth)acrylate, myristyl(meth)acrylate, palmityl(meth)acrylate, stearyl(meth)acrylate, and the like. Of these, butyl(meth)acrylate is preferable from the viewpoint of obtaining a sufficient adhesive strength even when the pressure sensitive adhesive layer is reduced in thickness.

Incidentally, these (meth)acrylate esters may be used solely or in combination of two or more kinds thereof. Incidentally, in the case of using a combination of two or more kinds of (meth)acrylate esters, one of the monomers is preferably butyl acrylate from the viewpoint of obtaining a sufficient adhesive strength even when the pressure sensitive adhesive layer is reduced in thickness. The content of butyl acrylate is preferably from 50 to 100% by mass, more preferably from 70 to 100% by mass, and still more preferably from 80 to 100% by mass, in the (meth)acrylate ester.

In addition, examples of the monomer having a crosslinkable functional group include ethylenically unsaturated carboxylic acids such as (meth)acrylic acid, itaconic acid, crotonic acid, maleic acid, fumaric acid, etc.; hydroxyalkyl(meth)acrylates such as 2-hydroxyethyl(meth)acrylate, 4-hydroxybutyl(meth)acrylate, 2-hydroxypropyl(meth)acrylate, 3-hydroxypropyl(meth)acrylate, 2-hydroxybutyl(meth)acrylate, 3-hydroxybutyl(meth)acrylate, etc.; monoalkylaminoalkyl(meth)acrylates such as monomethylaminoethyl(meth)acrylate, monoethylaminoethyl(meth)acrylate, monomethylaminopropyl(meth)acrylate, monoethylaminopropyl(meth)acrylate, etc.; and the like. Incidentally, these monomers may be used solely or in combination of two or more kinds thereof.

Of these, from the viewpoint of reactivity with the isocyanate based crosslinking agent and also from the viewpoint of obtaining a sufficiently high adhesive strength even when the pressure sensitive adhesive layer is reduced in thickness, ethylenically unsaturated carboxylic acids and hydroxyalkyl(meth)acrylates are preferable, and ethylenically unsaturated carboxylic acids are more preferable.

The content of the constituent unit derived from a monomer having a crosslinkable functional group in all of constituent units of the acrylic copolymer (2) is preferably from 0.1 to 20% by mass, more preferably from 0.5 to 15% by mass, and still more preferably from 1 to 12% by mass from the viewpoint of obtaining a sufficient adhesive strength even when the pressure sensitive adhesive layer is reduced in thickness.

As the constituent unit of the acrylic copolymer (2), a constituent unit derived from other monomer may be contained. Examples of other monomer include vinyl esters such as vinyl acetate, vinyl propionate, etc.; olefins such as ethylene, propylene, isobutylene, etc.; halogenated olefins such as vinyl chloride, vinylidene chloride, etc.; aromatic vinyl monomers such as styrene, methylstyrene, vinyltoluene, etc.; diene based monomers such as butadiene, isoprene, chloroprene, etc.; nitrile based monomers such as (meth)acrylonitrile, etc.; and the like. These monomers may be used solely or in combination of two or more kinds thereof.

In the present invention, the acrylic copolymer (2) is not particularly limited with respect to a copolymerization form thereof and may be any of a random, block, or graft copolymer.

Incidentally, from the foregoing viewpoints, the acrylic copolymer (2) contains a constituent unit derived from a monomer having a carboxy group in an amount of preferably from 0.1 to 20% by mass, more preferably from 0.5 to 15% by mass, and still more preferably from 1 to 12% by mass, in all of constituent units of the acrylic copolymer (2).

A weight average molecular weight of the acrylic copolymer (2) is preferably from 300,000 to 1,500,000, more preferably from 400,000 to 1,000,000, and still more preferably from 500,000 to 800,000 from the viewpoints of adhesive performance and the like. When the weight average molecular weight of the acrylic copolymer (2) is 300,000 or more, a cohesive strength of the pressure sensitive adhesive layer is enhanced, and a sufficient adhesive strength is obtained. In addition, when the weight average molecular weight of the acrylic copolymer (2) is not more than 1,500,000, the elastic modulus of the pressure sensitive adhesive layer does not become excessively high, and a lowering of the adhesive strength can be suppressed.

Similar to the foregoing, the preparation of the acrylic copolymer (2) can be conducted in the usual way in the presence or absence of a solvent. Examples of the solvent include ethyl acetate, toluene, and the like.

In addition, at the time of preparation, a polymerization initiator such as azobisisobutyronitrile, benzoyl peroxide, etc. may also be used. The addition amount of the polymerization initiator is preferably from 0.01 to 1 part by mass, and more preferably from 0.1 to 0.5 parts by mass, based on 100 parts by mass of the monomer mixture.

Though the polymerization conditions are not particularly limited, the polymerization is preferably conducted under conditions at from 50 to 90° C. for from 2 to 30 hours.

### (Other Resin Components)

The second pressure sensitive adhesive may further contain a urethane resin, an acrylic urethane resin, a urethane polyester resin, or the like as other resin component than the acrylic copolymer (2) having a crosslinkable functional group as the main component.

The urethane resin which is contained in the second pressure sensitive adhesive is not particularly limited, and the same urethane resins as those used in the first pressure sensitive adhesive can be used.

The acrylic urethane resin which is contained in the second pressure sensitive adhesive is not particularly limited, and examples thereof include copolymers obtained through copolymerization of a vinyl group-containing urethane polymer and a (meth)acrylic monomer, and the like.

The urethane polyester resin which is contained in the second pressure sensitive adhesive is not particularly limited, and examples thereof include copolymers obtained through cocondensation of a monomer having an isocyanate group, a monomer having a hydroxyl group, and a monomer having a carboxyl group, and the like.

### [Crosslinking Agent]

From the viewpoint of obtaining a higher adhesive strength, it is preferable that each of the first pressure sensitive adhesive and the second pressure sensitive adhesive further contains a crosslinking agent.

Examples of the crosslinking agent include isocyanate based crosslinking agents, epoxy based crosslinking agents, aziridine based crosslinking agents, metal chelate based crosslinking agents, amine based crosslinking agents, amino resin based crosslinking agents, and the like. Of these, isocyanate based crosslinking agents are preferable from the viewpoint of obtaining a high adhesive strength even when the pressure sensitive adhesive layer is reduced in thickness. Incidentally, these crosslinking agents may be used solely or in combination of two or more kinds thereof.

Examples of the isocyanate based crosslinking agent include polyvalent isocyanate compounds such as 2,4-tolylene diisocyanate, 2,6-tolylene diisocyanate, 1,3-xylylene diisocyanate, 1,4-xylylene diisocyanate, diphenylmethane-4,4′-diisocyanate, diphenylmethane-2,4′-diisocyanate, 3-methyldiphenylmethane diisocyanate, hexamethylene diisocyanate, isophorone diisocyanate, dicyclohexylmethane-4,4′-diisocyanate, dicyclohexylmethane-2,4′-diisocyanate, lysine isocyanate, etc.

Incidentally, the polyvalent isocyanate compound may be a modified product of the foregoing compound, for example, a trimethylolpropane adduct type modified product, a biuret type modified product obtained by a reaction with water, or an isocyanurate type modified product having an isocyanurate ring incorporated thereinto.

The epoxy based crosslinking agent is not particularly limited so long as it has two or more epoxy groups or glycidyl groups in a molecule thereof. However, polyfunctional epoxy compounds having two or more epoxy groups in one molecule thereof are preferable.

Examples of the polyfunctional epoxy compound include a diglycidyl ether of bisphenol A and an oligomer thereof, a diglycidyl ether of hydrogenated bisphenol A and an oligomer thereof, diglycidyl orthophthalate, diglycidyl isophthalate, diglycidyl terephthalate, glycidyl p-oxybenzoate, diglycidyl tetrahydrophthalate, diglycidyl hexahydrophthalate, diglycidyl succinate, diglycidyl adipate, diglycidyl sebacate, ethylene glycol diglycidyl ether, propylene glycol diglycidyl ether, 1,4-butanediol diglycidyl ether, 1,6-hexanediol diglycidyl ether, a polyalkylene glycol diglycidyl ether, triglycidyl trimellitate, triglycidyl isocyanurate, 1,4-diglycidyloxybenzene, diglycidylpropyleneurea, glycerol triglycidyl ether, trimethylolpropane di- or triglycidyl ether, pentaerythritol di- or triglycidyl ether, a triglycidyl ether of a glycerol alkylene oxide adduct, a diglycidylamine such as diglycidylaniline, etc., and the like.

Though the aziridine based crosslinking agent is not particularly limited, specific examples thereof include 1,1′-(methylene-di-p-phenylene)bis-3,3-aziridinylurea, 1,1′-(hexamethylene)bis-3,3-aziridinylurea, 2,4,6-triaziridinyl-1,3,5-triazine, trimethylolpropane-tris-(2-aziridinylpropionate), and the like.

Examples of the metal chelate based crosslinking agent include compounds in which acetylacetone, ethyl acetoacetate, or the like coordinates on a polyvalent metal such as aluminum, iron, copper, zinc, tin, titanium, nickel, antimony, magnesium, vanadium, chromium, zirconium, etc., and the like.

Examples of the amine based crosslinking agent include polyamines such as aliphatic polyamines (for example, triethylenetetramine, tetraethylenepentamine, ethylenediamine, N,N-dicinnamylidene-1,6-hexanediamine, trimethylenediamine, hexamethylenediamine carbamate, ethanolamine, 3,9-bis(3-aminopropyl)-2,4,8,10-tetraoxa-2-spiro[5.5]undecane, etc.) and salts thereof; and aromatic polyamines (for example, diaminodiphenylmethane, xylylenediamine, phenylenediamine, diaminodiphenyl sulfone, etc.).

Examples of the amino resin based crosslinking agent include methoxylated methylolurea, methoxylated methylol N,N-ethyleneurea, methoxylated methyloldicyanediamide, methoxylated methylolmelamine, methoxylated methylolbenzoguanamine, butoxylated methylolmelamine, butoxylated methylolbenzoguanamine, and the like. Of these, methoxylated methylolmelamine, butoxylated methylolmelamine, methylolated benzoguanamine, and the like are preferable.

Incidentally, these crosslinking agents may be used solely or in combination of two or more kinds thereof.

A blending amount of the crosslinking agent is preferably from 0.01 to 8 parts by mass, more preferably from 0.05 to 5 parts by mass, and still more preferably from 0.1 to 3 parts by mass, based on 100 parts by mass of the resin component of the first or second pressure sensitive adhesive from the viewpoint of obtaining a high adhesive strength even when the pressure sensitive adhesive layer is reduced in thickness.

In addition, in order to exhibit adhesiveness upon crosslinking (reaction) with the crosslinking agent blended in the first or second pressure sensitive adhesive, after coating the blend on a base material or a release material, it is preferable to conduct a heat treatment. As for temperature conditions of the heat treatment, the temperature is preferably from 70° C. to 150° C., and more preferably from 70 to 120° C. In addition, a treatment time of the heat treatment is preferably from 30 seconds to 5 minutes, and more preferably from 30 to 180 seconds.

### [Other Components]

Each of the first pressure sensitive adhesive and the second pressure sensitive adhesive can be blended with other component within the range where the effects of the present invention are not impaired. Examples of other component include an ultraviolet absorber, an antioxidant, an antiseptic, an anti-mold agent, a tackifier, a plasticizer, a defoaming agent, a wettability regulator, and the like.

### [Base Material]

The base material 11 which is used in the pressure sensitive adhesive sheet according to the present invention is not particularly limited and is properly chosen depending upon the use purpose of the pressure sensitive adhesive sheet. Examples thereof include woven fabrics or nonwoven fabrics using fibers such as rayon fibers, acrylic fibers, polyester fibers, etc.; papers such as wood-free paper, glassine paper, impregnated paper, coated paper, etc.; metal foils such as aluminum, copper, etc.; foamed materials such as urethane foamed materials, polyethylene foamed materials, etc.; plastic films such as a polyester film made of polyethylene terephthalate, polybutylene terephthalate, polyethylene naphthalate, etc., a polyurethane film, a polyethylene film, a polypropylene film, a polyvinyl chloride film, a polyvinylidene chloride film, a polyvinyl alcohol film, an ethylene-vinyl acetate copolymer film, a polystyrene film, a polycarbonate film, an acrylic resin film, a norbornene based resin film, a cycloolefin resin film, etc.; laminates composed of two or more kinds thereof; and the like.

Of these, polyester films made of polyethylene terephthalate, etc. and polyvinyl chloride films are preferable from viewpoints of thickness precision required following the reduction in thickness, surface smoothness, and availability.

Though a thickness of the base material is not particularly limited, it is usually from 1 to 300 μm, preferably from 2 to 200 μm, more preferably from 4 to 100 μm, and still more preferably from 6 to 50 μm from the viewpoint of easiness of handling.

### [Release Material]

Though the release material 14 which is used in the pressure sensitive adhesive sheet according to the present invention is not particularly limited, a release sheet obtained by coating a release agent on a base material is preferable from the viewpoint of easiness of handling. The release sheet may be either a release sheet obtained by coating a release agent on the both surfaces of a base material, followed by a release treatment, or a release sheet obtained by coating a release agent on only one surface of a base material, followed by a release treatment.

Examples of the base material of the release sheet include a paper based material such as glassine paper, coated paper, cast-coated paper, etc.; a laminate paper obtained by laminating a thermoplastic resin such as polyethylene, etc. on such a paper base material; a plastic film such as a polyester film made of polyethylene terephthalate, polybutylene terephthalate, polyethylene naphthalate, etc., a polyolefin film made of polypropylene, polyethylene, etc.; and the like.

Examples of the release agent include a rubber based elastomer such as an olefin based resin, an isoprene based resin, a butadiene based resin, etc., a long-chain alkyl based resin, an alkyd based resin, a fluorine based resin, a silicone based resin, and the like.

Though a thickness of the release sheet is not particularly limited, it is usually from 20 to 200 μm, and preferably from 25 to 150 μm.

Though the thickness of the layer made of a release agent of the release sheet is not particularly limited, in the case of coating the release agent in a solution state, the thickness is preferably from 0.01 to 2.0 μm, and more preferably from 0.03 to 1.0 μm. In the case of using a plastic film as the base material of the release sheet, the thickness of the layer made of a release agent is preferably from 3 to 50 μm, and more preferably from 5 to 40 μm.

### [Production Method of Pressure Sensitive Adhesive Sheet]

A production method of the pressure sensitive adhesive sheet according to the present invention is not particularly limited. For example, the pressure sensitive adhesive sheet may be fabricated by simultaneously coating the first pressure sensitive adhesive layer 12 and the second pressure sensitive adhesive layer 13 on the base material 11 using a multiple die coater capable of conducting double-layer coating, followed by drying; or may be fabricated by coating the first pressure sensitive adhesive and drying to form the first pressure sensitive adhesive layer 12 and then coating the second pressure sensitive adhesive on the first pressure sensitive adhesive layer 12 and drying to form the second pressure sensitive adhesive layer 13.

Besides, the pressure sensitive adhesive sheet may also be fabricated by coating the first pressure sensitive adhesive on the base material 11 and drying to form the first pressure sensitive adhesive layer 12; on the other hand, coating the second pressure sensitive adhesive on the surface of the release material which has been subjected to a release treatment and drying to form the second pressure sensitive adhesive layer 13; and then superposing the first pressure sensitive adhesive layer 12 and the second pressure sensitive adhesive layer 13 on each other.

The method for forming the first pressure sensitive adhesive layer and the second pressure sensitive adhesive layer on the base material or the release material is not particularly limited. However, in order to reduce the pressure sensitive adhesive layer in thickness, a method in which each of the first pressure sensitive adhesive and the second pressure sensitive adhesive is diluted with an organic solvent and converted to a form of a pressure sensitive adhesive solution, followed by forming in the known coating method is preferable; and a method in which the first pressure sensitive adhesive solution is coated on the base material and dried to form the first pressure sensitive adhesive layer, and the second pressure sensitive adhesive on the surface of the release material which has been subjected to a release treatment and dried to form the second pressure sensitive adhesive layer, followed by superposition is more preferable.

Examples of the organic solvent to be used include toluene, ethyl acetate, methyl ethyl ketone, and the like. By blending these organic solvents to moderately adjust a solid content of the pressure sensitive adhesive solution, a pressure sensitive adhesive layer which has been reduced in thickness can be easily formed.

The solid content of the pressure sensitive adhesive solution is preferably from 5 to 60% by mass, and more preferably from 10 to 40% by mass. When the solid content of the pressure sensitive adhesive solution is 5% by mass or more, the use amount of the solvent is sufficient, whereas when it is not more than 60% by mass, the viscosity is moderate, so that at the time of coating the pressure sensitive adhesive solution, the workability becomes satisfactory.

Incidentally, at the time of producing a resin which is contained in the first or second pressure sensitive adhesive, in the case where the produced resin is in a state of being contained in the organic solvent, the preparation may also be conducted by dilution with the same organic solvent to adjust the solid content to the foregoing range.

Examples of the coating method include known methods such as a spin coating method, a spray coating method, a bar coating method, a knife coating method, a roll coating method, a blade coating method, a die coating method, a gravure coating method, etc. In addition, after coating a solution of the pressure sensitive adhesive composition dissolved in an organic solvent on the base material or the release layer surface of the release sheet, in order to prevent retention of the solvent or low-boiling component from occurring, it is preferable to conduct a heat treatment at a temperature of from 70 to 150° C. for from about 30 seconds to 5 minutes. In addition, in the case where the crosslinking agent is blended in the first or second pressure sensitive adhesive, by conducting a heat treatment, the crosslinking (reaction) proceeds, thereby exhibiting high adhesiveness.

### EXAMPLES

Pressure sensitive adhesives (solutions) used in the Examples and Comparative Examples are shown below. (1) Urethane resin [U1]-containing pressure sensitive adhesive:

### Production Example 1

100 parts by mass of polypropylene glycol (Mw: 2,000) as a polyol compound, 10.1 parts by mass of hexamethylene diisocyanate as a polyvalent isocyanate compound, and 0.01 parts by mass of dibutyltin dilaurate as a catalyst were subjected to gradual temperature rising to 85° C., and the mixture was then stirred for 2 hours to obtain an isocyanate-terminated urethane prepolymer ((NCO group)/(OH group)=1.2).

To the obtained isocyanate-terminated urethane prepolymer, 110 parts by mass of toluene was added, and the mixture was gradually cooled to room temperature. Thereafter, 0.48 parts by mass of 1,4-butanediol and 0.12 parts by mass of trimethylolpropane were added dropwise as a chain extender, and after gradually rising the temperature to 70° C., the mixture was stirred for 2 hours to obtain a toluene solution of a urethane resin [U1] having a weight average molecular weight of 160,000 (solid content: 50.2% by mass).

Then, 1.875 parts by mass (solid content) of an isocyanate based crosslinking agent (an ethyl acetate solution of trimethylolpropane-modified tolylene diisocyanate, solid content: 75% by mass, a trade name: CORONATE L, available from Nippon Polyurethane Industry Co., Ltd.) was added as a crosslinking agent to 100 parts by mass (solid content) of the obtained urethane resin [U1], and the mixture was diluted with toluene such that the solid content was 10% by mass, thereby preparing a urethane resin [U1]-containing pressure sensitive adhesive solution.

### (2) Urethane Resin [U2]-Containing Pressure Sensitive Adhesive:

### Production Example 2

A trade name, “BINSOL U-250”, available from Ipposha Oil Industries Co., Ltd. was used as a urethane resin [U2], and to 100 parts by mass (solid content) of the urethane resin [U2], 1.875 parts by mass (solid content) of an isocyanate based crosslinking agent (an ethyl acetate solution of trimethylolpropane-modified tolylene diisocyanate, solid content: 75% by mass, a trade name: CORONATE L, available from Nippon Polyurethane Industry Co., Ltd.) was added as a crosslinking agent, and the mixture was diluted with toluene such that the solid content was 10% by mass, thereby preparing a urethane resin [U2]-containing pressure sensitive adhesive solution.

### (3) Acrylic Copolymer [A1]-Containing Pressure Sensitive Adhesive:

### Production Example 3

90 parts by mass of butyl acrylate and 10 parts by mass of acrylic acid as monomer components, 200 parts by mass of ethyl acetate as a solvent, and 0.2 parts by mass of azobisisobutyronitrile as a polymerization initiator were charged into a reactor and mixed. Deaeration with a nitrogen gas was conducted for 4 hours, and after gradually rising the temperature to 60° C., a polymerization reaction was conducted with stirring for 24 hours, thereby obtaining an ethyl acetate solution of an acrylic copolymer [A1] having a weight average molecular weight of 650,000 (solid content: 33% by mass).

Then, 1.5 parts by mass (solid content) of an isocyanate based crosslinking agent (an ethyl acetate solution of trimethylolpropane-modified tolylene diisocyanate, solid content: 75% by mass, a trade name: CORONATE L, available from Nippon Polyurethane Industry Co., Ltd.) was added as a crosslinking agent to 100 parts by mass (solid content) of the obtained acrylic copolymer [A1], and the mixture was diluted with ethyl acetate such that the solid content was 10% by mass, thereby preparing an acrylic copolymer [A1]-containing pressure sensitive adhesive solution.

(4) Pressure Sensitive Adhesive Containing Resin Mixture [U1+A1] of urethane resin [U1] and acrylic copolymer [A1]:

### Production Example 4

To a resin mixture [U1+A1] of 100 parts by mass (solid content) of the urethane resin [U1] obtained in Production Example 1 and 25 parts by mass (solid content) of the acrylic copolymer [A1] obtained in Production Example 2, 2.25 parts by mass (solid content) of the same isocyanate based crosslinking agent as that in Production Example 1 was added as a crosslinking agent, and the mixture was diluted with ethyl acetate such that the solid content was 10% by mass, thereby preparing a pressure sensitive adhesive solution containing a resin mixture [U1+A1] of urethane resin [U1] and acrylic copolymer [A1], (in the pressure sensitive adhesive, (urethane resin)/(acrylic copolymer)=100/25 (mass ratio), acrylic copolymer content: 20% by mass).

### (5) Acrylic Copolymer [A2]-Containing Pressure Sensitive Adhesive:

### Production Example 5

96 parts by mass of butyl acrylate and 4 parts by mass of acrylic acid as monomer components, 200 parts by mass of ethyl acetate as a solvent, and 0.2 parts by mass of azobisisobutyronitrile as a polymerization initiator were charged into a reactor and mixed. Deaeration with a nitrogen gas was conducted for 4 hours, and after gradually rising the temperature to 60° C., a polymerization reaction was conducted with stirring for 24 hours, thereby obtaining an ethyl acetate solution of an acrylic copolymer [A2] having a weight average molecular weight of 800,000 (solid content: 33% by mass).

Then, 1.5 parts by mass (solid content) of the same isocyanate crosslinking agent as that in Production Example 3 was added as a crosslinking agent to 100 parts by mass (solid content) of the obtained acrylic copolymer [A2], and the mixture was diluted with ethyl acetate such that the solid content was 10% by mass, thereby preparing an acrylic copolymer [A2]-containing pressure sensitive adhesive solution.

### (6) Acrylic Copolymer [A3]-Containing Pressure Sensitive Adhesive:

### Production Example 6

95 parts by mass of butyl acrylate and 5 parts by mass of 4-hydroxybutyl acrylate as monomer components, 200 parts by mass of ethyl acetate as a solvent, and 0.2 parts by mass of azobisisobutyronitrile as a polymerization initiator were charged into a reactor and mixed. Deaeration with a nitrogen gas was conducted for 4 hours, and after gradually rising the temperature to 60° C., a polymerization reaction was conducted with stirring for 24 hours, thereby obtaining an ethyl acetate solution of an acrylic copolymer [A3] having a weight average molecular weight of 600,000 (solid content: 33% by mass).

Then, 1.5 parts by mass (solid content) of the same isocyanate crosslinking agent as that in Production Example 3 was added as a crosslinking agent to 100 parts by mass (solid content) of the obtained acrylic copolymer [A3], and the mixture was diluted with ethyl acetate such that the solid content was 10% by mass, thereby preparing an acrylic copolymer [A3]-containing pressure sensitive adhesive solution.

### (7) Butyl Rubber [B]-Containing Pressure Sensitive Adhesive:

### Production Example 7

To 100 parts by mass (solid content) of a trade name, “BUTYL 365”, available from JSR Corporation (degree of unsaturation: 2.0% by mole, Mw: 270,000) as a butyl rubber (isobutene-isoprene copolymer) [B], 1 part by mass of benzophenone was added as a photopolymerization initiator, and the mixture was diluted with toluene such that the solid content was 10% by mass, thereby preparing a butyl rubber [B]-containing pressure sensitive adhesive solution.

### (8) SIS [SI]-Containing Pressure Sensitive Adhesive:

### Production Example 8

To 100 parts by mass (solid content) of a trade name, “Quintac 3421”, available from Zeon Corporation (styrene content: 14% by mass, Mw: 120,000) as SIS (styrene-isobutene-styrene block copolymer) [SI], 1 part by mass of hydroxy-cyclohexyl-phenyl-ketone (a trade name: “IRGACURE® 184”, available from Ciba Specialty Chemicals) was added as a photopolymerization initiator, and the mixture was diluted with toluene such that the solid content was 10% by mass, thereby preparing an SIS [S]-containing pressure sensitive adhesive solution.

### (9) SEB [SE]-Containing Pressure Sensitive Adhesive:

### Production Example 9

To a trade name, “CLAYTON G1657”, available from Shell Chemicals (styrene content: 13% by mass, Mw: 55,000) as SEB (styrene-ethylene-butylene copolymer) [SE], 1 part by mass of benzophenone was added as a photopolymerization initiator, and the mixture was diluted with toluene such that the solid content was 10% by mass, thereby preparing an SEB [SE]-containing pressure sensitive adhesive solution.

### Example 1

### (1) Formation of First Pressure Sensitive Adhesive Layer:

The urethane resin [U1]-containing pressure sensitive adhesive solution prepared in Production Example 1 was coated on the surface of a 25 μm-thickness polyester film (base material, a trade name: “T-100”, available from Mitsubishi Polyester Film) such that a thickness of the pressure sensitive adhesive layer after drying was 1 μm and heated for drying at 100° C. for one minute, thereby forming a first pressure sensitive adhesive layer. Then, a light-release film (silicone-treated polyester film having a thickness of 38 μm; a trade name: “SP-PET381031”, available from Lintec Corporation) was laminated on the formed first pressure sensitive adhesive layer, thereby fabricating a sheet having the first pressure sensitive adhesive layer.

### (2) Formation of Second Pressure Sensitive Adhesive Layer:

The acrylic copolymer [A1]-containing pressure sensitive adhesive solution prepared in Production Example 2 was coated on the silicone-treated surface of a heavy-release film (silicone-treated polyester film having a thickness of 38 μm; a trade name: “SP-PET38T103-1”, available from Lintec Corporation) such that a thickness of the pressure sensitive adhesive layer after drying was μm and heated for drying at 100° C. for one minute, thereby forming a second pressure sensitive adhesive layer. Then, the same light-release film as that described above was laminated on the formed second pressure sensitive adhesive layer, thereby fabricating a sheet having the second pressure sensitive adhesive layer.

### (3) Fabrication of Pressure Sensitive Adhesive Sheet:

Each of the light-release films of the sheet having the first pressure sensitive adhesive layer and the sheet having the second pressure sensitive adhesive layer was peeled off, and the both sheets were superposed on each other such that the second pressure sensitive adhesive layer was laminated on the first pressure sensitive adhesive layer, thereby fabricating a heavy-release film-provided pressure sensitive adhesive sheet.

### Example 2

A pressure sensitive adhesive sheet was fabricated in the same manner as that in Example 1 by using, as the first pressure sensitive adhesive, the urethane resin [U1]-containing pressure sensitive adhesive solution prepared in Production Example 1 and using, as the second pressure sensitive adhesive, the pressure sensitive adhesive solution containing a resin mixture [U1+A1] of urethane resin [U1] and acrylic copolymer [A1] prepared in Production Example 4.

### Example 3

A pressure sensitive adhesive sheet was fabricated in the same manner as that in Example 1, except that the butyl rubber [B]-containing pressure sensitive adhesive solution prepared in Production Example 7 was used as the first pressure sensitive adhesive; that the acrylic copolymer [A1]-containing pressure sensitive adhesive solution prepared in Production Example 3 was used as the second pressure sensitive adhesive; and that the butyl rubber [B]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Example 4

A pressure sensitive adhesive sheet was fabricated in the same manner as that in Example 1, except that the butyl rubber [B]-containing pressure sensitive adhesive solution prepared in Production Example 7 was used as the first pressure sensitive adhesive; that the pressure sensitive adhesive solution containing a resin mixture [U1+A1] of urethane resin [U1] and acrylic copolymer [A1] prepared in Production Example 4 was used as the second pressure sensitive adhesive; and that the butyl rubber [B]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Example 5

A pressure sensitive adhesive sheet was fabricated in the same manner as that in Example 1 by using, as the first pressure sensitive adhesive, the acrylic copolymer [A2]-containing pressure sensitive adhesive solution prepared in Production Example 5 and using, as the second pressure sensitive adhesive, the acrylic copolymer [A1]-containing pressure sensitive adhesive solution prepared in Production Example 3.

### Example 6

A pressure sensitive adhesive sheet was fabricated in the same manner as that in Example 1 by using, as the first pressure sensitive adhesive, the acrylic copolymer [A2]-containing pressure sensitive adhesive solution prepared in Production Example 5 and using, as the second pressure sensitive adhesive, the pressure sensitive adhesive solution containing a resin mixture [U1+A1] of urethane resin [U1] and acrylic copolymer [A1] prepared in Production Example 4.

### Example 7

A pressure sensitive adhesive sheet was fabricated in the same manner as that in Example 1 by using, as the first pressure sensitive adhesive, the urethane resin [U2]-containing pressure sensitive adhesive solution prepared in Production Example 2 and using, as the second pressure sensitive adhesive, the acrylic copolymer [A1]-containing pressure sensitive adhesive solution prepared in Production Example 3.

### Example 8

A pressure sensitive adhesive sheet was fabricated in the same manner as that in Example 1 by using, as the first pressure sensitive adhesive, the urethane resin [U2]-containing pressure sensitive adhesive solution prepared in Production Example 2 and using, as the second pressure sensitive adhesive, the pressure sensitive adhesive solution containing a resin mixture [U1+A1] of urethane resin [U1] and acrylic copolymer [A1] prepared in Production Example 4.

### Comparative Example 1

A pressure sensitive adhesive sheet was fabricated in the same manner as that in Example 1 by using, as the first pressure sensitive adhesive, the acrylic copolymer [A1]-containing pressure sensitive adhesive solution prepared in Production Example 3 and using, as the second pressure sensitive adhesive, the urethane resin [U1]-containing pressure sensitive adhesive solution prepared in Production Example 1.

### Comparative Example 2

A pressure sensitive adhesive sheet was fabricated in the same manner as that in Example 1 by using, as the first pressure sensitive adhesive, the urethane resin [U1]-containing pressure sensitive adhesive solution prepared in Production Example 1 and using, as the second pressure sensitive adhesive, the urethane resin [U1]-containing pressure sensitive adhesive solution prepared in Production Example 1, too.

### Comparative Example 3

A pressure sensitive adhesive sheet was fabricated in the same manner as that in Example 1 by using, as the first pressure sensitive adhesive, the acrylic copolymer [A1]-containing pressure sensitive adhesive solution prepared in Production Example 3 and using, as the second pressure sensitive adhesive, the acrylic copolymer [A1]-containing pressure sensitive adhesive solution prepared in Production Example 3, too.

### Comparative Example 4

A pressure sensitive adhesive sheet was fabricated in the same manner as that in Example 1, except that the butyl rubber [B]-containing pressure sensitive adhesive solution prepared in Production Example 7 was used as the first pressure sensitive adhesive; that the urethane resin [U1]-containing pressure sensitive adhesive solution prepared in Production Example 1 was used as the second pressure sensitive adhesive; and that the butyl rubber [B]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Comparative Example 5

A pressure sensitive adhesive sheet was fabricated in the same manner as that in Example 1, except that the urethane resin [U1]-containing pressure sensitive adhesive solution prepared in Production Example 1 was used as the first pressure sensitive adhesive; that the butyl rubber [B]-containing pressure sensitive adhesive solution prepared in Production Example 7 was used as the second pressure sensitive adhesive; and that the butyl rubber [B]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Comparative Example 6

A pressure sensitive adhesive sheet was fabricated in the same manner as that in Example 1, except that the acrylic copolymer [A1]-containing pressure sensitive adhesive solution prepared in Production Example 3 was used as the first pressure sensitive adhesive; that the butyl rubber [B]-containing pressure sensitive adhesive solution prepared in Production Example 7 was used as the second pressure sensitive adhesive; and that the butyl rubber [B]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Comparative Example 7

A pressure sensitive adhesive sheet was fabricated in the same manner as that in Example 1, except that the SIS [SI]-containing pressure sensitive adhesive solution prepared in Production Example 8 was used as the first pressure sensitive adhesive; that the urethane resin [U1]-containing pressure sensitive adhesive solution prepared in Production Example 1 was used as the second pressure sensitive adhesive; and that the SIS [SI]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Comparative Example 8

A pressure sensitive adhesive sheet was fabricated in the same manner as that in Example 1, except that the urethane resin [U1]-containing pressure sensitive adhesive solution prepared in Production Example 1 was used as the first pressure sensitive adhesive; that the SIS [SI]-containing pressure sensitive adhesive solution prepared in Production Example 8 was used as the second pressure sensitive adhesive; and that the SIS [SI]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Comparative Example 9

A pressure sensitive adhesive sheet was fabricated in the same manner as that in Example 1, except that the SIS [SI]-containing pressure sensitive adhesive solution prepared in Production Example 8 was used as the first pressure sensitive adhesive; that the acrylic copolymer [A1]-containing pressure sensitive adhesive solution prepared in Production Example 3 was used as the second pressure sensitive adhesive; and that the SIS [SI]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Comparative Example 10

A pressure sensitive adhesive sheet was fabricated in the same manner as that in Example 1, except that the acrylic copolymer [A1]-containing pressure sensitive adhesive solution prepared in Production Example 3 was used as the first pressure sensitive adhesive; that the SIS [SI]-containing pressure sensitive adhesive solution prepared in Production Example 8 was used as the second pressure sensitive adhesive; and that the SIS [SI]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Comparative Example 11

A pressure sensitive adhesive sheet was fabricated in the same manner as that in Example 1, except that the SIS [SI]-containing pressure sensitive adhesive solution prepared in Production Example 8 was used as the first pressure sensitive adhesive; that the pressure sensitive adhesive solution containing a resin mixture [U1+A1] of urethane resin [U1] and acrylic copolymer [A1] prepared in Production Example 4 was used as the second pressure sensitive adhesive; and that the SIS [SI]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Comparative Example 12

A pressure sensitive adhesive sheet was fabricated in the same manner as that in Example 1 by using, as the first pressure sensitive adhesive, the acrylic copolymer [A3]-containing pressure sensitive adhesive solution prepared in Production Example 6 and using, as the second pressure sensitive adhesive, the acrylic copolymer [A1]-containing pressure sensitive adhesive solution prepared in Production Example 3.

### Comparative Example 13

A pressure sensitive adhesive sheet was fabricated in the same manner as that in Example 1 by using, as the first pressure sensitive adhesive, the acrylic copolymer [A3]-containing pressure sensitive adhesive solution prepared in Production Example 6 and using, as the second pressure sensitive adhesive, the pressure sensitive adhesive solution containing a resin mixture [U1+A1] of urethane resin [U1] and acrylic copolymer [A1] prepared in Production Example 4.

### Comparative Example 14

A pressure sensitive adhesive sheet was fabricated in the same manner as that in Example 1, except that the SEB [SE]-containing pressure sensitive adhesive solution prepared in Production Example 9 was used as the first pressure sensitive adhesive; that the acrylic copolymer [A1]-containing pressure sensitive adhesive solution prepared in Production Example 3 was used as the second pressure sensitive adhesive; and that the SEB [SE]-containing pressure sensitive adhesive solution was coated on the base material, heated for drying at 100° C. for one minute, and then irradiated with ultraviolet rays (illuminance: 600 mW/cm², quantity of light: 150 mJ/cm²).

### Comparative Example 15

A pressure sensitive adhesive sheet was fabricated in the same manner as that in Example 1, except that the SEB [SE]-containing pressure sensitive adhesive solution prepared in Production Example 9 was used as the first pressure sensitive adhesive; that the pressure sensitive adhesive solution containing a resin mixture [U1+A1] of urethane resin [U1] and acrylic copolymer [A1] prepared in Production Example 4 was used as the second pressure sensitive adhesive; and that the SEB [SE]-containing pressure sensitive adhesive solution was coated on the base material, heated for drying at 100° C. for one minute, and then irradiated with ultraviolet rays (illuminance: 600 mW/cm², quantity of light: 150 mJ/cm²).

The thus obtained pressure sensitive adhesives or pressure sensitive adhesive sheets were evaluated by conducting the following tests. The evaluation results are shown in Table 1.

### (1) Measurement of Loss Tangent (tan δ):

A cylindrical test piece having a diameter of 8 mm and a thickness of 2 mm was fabricated from the pressure sensitive adhesive and determined for a loss tangent (tan δ) at 0° C. by the torsional shear method at a frequency of Hz using an analyzer, “Modular Compact Rheometer MCR 300”, available from Physica.

### (2) Measurement of Storage Elastic Modulus (G′):

A cylindrical test piece having a diameter of 8 mm and a thickness of 2 mm was fabricated from the pressure sensitive adhesive and determined for a storage elastic modulus (G′) at 0° C. by the torsional shear method at a frequency of 1 Hz using an analyzer, “Modular Compact Rheometer MCR 300”, available from Physica.

### (3) Measurement of Adhesive Strength:

After fabricating the pressure sensitive adhesive sheet, the pressure sensitive adhesive sheet was cut into a size of 25 mm×300 mm, thereby fabricating a pressure sensitive adhesive sheet test piece. The heavy-release film of the pressure sensitive adhesive sheet test piece was peeled off in an environment at 23° C. and a relative humidity of 50%, and the second pressure sensitive adhesive layer was stuck onto an adherend (SUS304 steel plate, #280 polished) by reciprocating once a roller having a weight of 2 kg, thereby preparing a test sample. After sticking, the test sample was allowed to stand in an environment at 23° C. and a relative humidity of 50% for 24 hours. The resulting test sample was measured in the same environment using a tensile tester (a trade name: “TENSILON”, available from Orientec Co., Ltd.) under conditions at a peeling rate of 300 mm/min and at a peeling angle of 180°, and the measured value (N/25 mm) was defined as the adhesive strength.

TABLE 1

| | First pressure sensitive adhesive* | | | Second pressure | |
|---|---|---|---|---|---|
| | | | Storage elastic | sensitive | Adhesive |
| | Resin | Loss tangent | modulus (G′) | adhesive* | strength |
| | component | (tan δ) | (MPa) | Resin component | (N/25 mm) |
| Example 1 | U1 | 0.53 | 0.17 | A1 | 9.7 |
| Example 2 | U1 | 0.53 | 0.17 | U1 + A1 | 9.0 |
| Example 3 | B | 0.36 | 0.24 | A1 | 7.2 |
| Example 4 | B | 0.36 | 0.24 | U1 + A1 | 7.5 |
| Example 5 | A2 | 0.41 | 0.10 | A1 | 6.0 |
| Example 6 | A2 | 0.41 | 0.10 | U1 + A1 | 6.3 |
| Example 7 | U2 | 0.78 | 0.02 | A1 | 6.0 |
| Example 8 | U2 | 0.78 | 0.02 | U1 + A1 | 6.5 |
| Comparative | A1 | 1.23 | 0.92 | U1 | 4.0 |
| Example 1 | | | | | |
| Comparative | U1 | 0.53 | 0.17 | U1 | 4.5 |
| Example 2 | | | | | |
| Comparative | A1 | 1.23 | 0.92 | A1 | 3.2 |
| Example 3 | | | | | |
| Comparative | B | 0.36 | 0.24 | U1 | 3.0 |
| Example 4 | | | | | |
| Comparative | U1 | 0.53 | 0.17 | B | 1.5 |
| Example 5 | | | | | |
| Comparative | A1 | 1.23 | 0.92 | B | 1.0 |
| Example 6 | | | | | |
| Comparative | SI | 0.16 | 0.32 | U1 | 0.8 |
| Example 7 | | | | | |
| Comparative | U1 | 0.53 | 0.17 | SI | 0.5 |
| Example 8 | | | | | |
| Comparative | SI | 0.16 | 0.32 | A1 | 1.2 |
| Example 9 | | | | | |
| Comparative | A1 | 1.23 | 0.92 | SI | 0.2 |
| Example 10 | | | | | |
| Comparative | SI | 0.16 | 0.32 | U1 + A1 | 1.2 |
| Example 11 | | | | | |
| Comparative | A3 | 0.21 | 0.30 | A1 | 1.8 |
| Example 12 | | | | | |
| Comparative | A3 | 0.21 | 0.30 | U1 + A1 | 0.6 |
| Example 13 | | | | | |
| Comparative | SE | 0.07 | 0.75 | A1 | 2.0 |
| Example 14 | | | | | |
| Comparative | SE | 0.07 | 0.75 | U1 + A1 | 2.0 |
| Example 15 | | | | | |

*U1: Urethane resin obtained in Production Example 1
U2: Urethane resin obtained in Production Example 2
A1: Acrylic copolymer obtainedin Production Example 3
A2: Acrylic copolymer obtained in Production Example 5
A3: Acrylic copolymer obtained in Production Example 6
U1 + A1: Resin mixture obtained by mixing the urethane resin (U1) and the acrylic copolymer (A1) in a ratio of 100/25
B: Butyl rubber (a trade name: “BUTYL 365”, available from JSR Corporation)
SI: Styrene-isobutene-styrene block copolymer (SIS) (a trade name, “Quintac 3421”, available from Zeon Corporation)
SE: Styrene-ethylene-butylene copolymer (a trade name: “CLAYTON G1657”, available from Shell Chemicals)

It is noted from Table 1 that the pressure sensitive adhesive sheet having first and second pressure sensitive adhesive layers as specified in the present invention exhibits a sufficient adhesive strength even when the total thickness of the first and second pressure sensitive adhesive layers is reduced to 2 μm.

On the other hand, in Comparative Examples 1 to 15, the reduction of the total thickness of the first and second pressure sensitive adhesive layers to 2 μm resulted in an inferior adhesive strength.

### INDUSTRIAL APPLICABILITY

The pressure sensitive adhesive sheet according to the present invention may become a pressure sensitive adhesive sheet having an excellent adhesive strength even when the pressure sensitive adhesive layer is reduced in thickness to not more than 5.0 μm. Accordingly, the present invention is able to contribute to miniaturization and reduction in thickness of portable electronic appliances, and hence, it is suitable for applications of electronic appliances, optical appliances, and the like.

### REFERENCE SIGNS LIST

1, 1a, 1b: Pressure sensitive adhesive sheet

11: Base material

12, 12a, 12b: First pressure sensitive adhesive layer

13, 13a, 13b: Second pressure sensitive adhesive layer

14: Release material

1. A pressure sensitive adhesive sheet comprising a pressure sensitive adhesive layer on a surface of a base material,
wherein
the pressure sensitive adhesive layer is made of a two-layer structure of a first pressure sensitive adhesive layer and a second pressure sensitive adhesive layer in this order from a side of the base material;
a first pressure sensitive adhesive constituting the first pressure sensitive adhesive layer has a loss tangent (tan δ) value at 0° C. of 0.25 or more and a storage elastic modulus value at 0° C. of from 0.01 to 0.80 MPa; and
a resin component in a second pressure sensitive adhesive constituting the second pressure sensitive adhesive layer comprises of from 10 to 100% by mass of an acrylic copolymer having a crosslinkable functional group.

2. The pressure sensitive adhesive sheet according to claim 1, wherein the acrylic copolymer comprises of from 0.1 to 20% by mass of a constituent unit derived from a monomer having a carboxy group in all constituent units of the acrylic copolymer.

3. The pressure sensitive adhesive sheet according to claim 1, wherein the first pressure sensitive adhesive comprises a urethane resin, a butyl rubber, or an acrylic copolymer.

4. The pressure sensitive adhesive sheet according to claim 1, wherein a total thickness of the first pressure sensitive adhesive layer and the second pressure sensitive adhesive layer is from 0.50 to 5.0 μm.
